(19) United States
(12) Patent Application Publication
(10) Pub. No.: US 2017/0295839 A1
(43) Pub. Date: Oct. 19, 2017

(54) SEPARABLE SHELL FOR RECEIVING CANDY COATING AND STORING TOY

(71) Applicant: Candy Treasure LLC, Lebanon, NJ (US)

(72) Inventor: Kevin Gass, Lebanon, NJ (US)

(21) Appl. No.: 15/488,248

(22) Filed: Apr. 14, 2017

Related U.S. Application Data
(60) Provisional application No. 62/326,338, filed on Apr. 22, 2016.
(60) Provisional application No. 62/322,542, filed on Apr. 14, 2016.

(51) Int. Cl. A23P 20/10; B65D 65/46; B65D 25/34

(52) U.S. Cl. CPC A23P 20/10; B65D 25/34; B65D 65/463

(57) ABSTRACT

The present disclosure is directed to a container including a first section, a second section and a ridge formed of a plurality of bollards projecting from one of the first or second section. The container including a plurality of receptacles formed by the orientation of the bollards with respect to each other.

### FIELD OF THE DISCLOSURE

The present disclosure relates generally to children's toys, and more particularly, to containers for storing children's toys having an edible coating.

### BACKGROUND OF THE PRESENT DISCLOSURE

Children's toys and candies come in numerous shapes and sizes, and competition among vendors to attract consumers to buy their particular toys and candies is fierce. One technique utilized by candy and toy vendors is to enclose small toys within food or candy packaging. Breakfast cereals and packaged snacks, such as Cracker Jack®, provide well-known and common examples of enclosing small toys within food products.

Other examples enclosing small toys inside hollow containers have been previously disclosed. In one example a hollow, plastic hinged Easter egg for containing candy or small toys is disclosed. In a second a food product package having two half shells that fit together to form a hollow egg that encloses a toy in one shell and candy in the other shell. However, these combination toy and candy products are highly regulated.

The Food and Drug Administration (FDA) regulates the edible portion of confectionery novelty products, and the Consumer Product Safety Commission (CPSC) regulates the toys contained inside or in proximity to such products. Both the FDA and CPSC have taken a position that if toys and containers containing toys are formed to a confection or encased within a confection, both the toys and any container containing said toys need to be safe for children of all ages. The CPSC rulings require that all non-edible materials in toys must comply with the requirements for small parts (16 C.F.R. Part 1501) and the guidelines for sharp points (16 C.F.R. §1500.48). Furthermore, §402(d)(1) of the Federal Food, Drug and Cosmetic Act requires that toy-containing products must not be embedded in a candy coating:
A food shall be deemed to be adulterated—If it is confectionery, and has partially or completely imbedded therein any nonnutritive object, except that this subparagraph shah not apply in the case of any nonnutritive object if, in the judgment of the Secretary as provided by regulations, such object is of practical functional value to the confectionery product and would not render the product injurious or hazardous to health.

Because these products are highly regulated, improvements have been developed to meet the regulations. For example one such disclosure taught a non-edible product shaped like a hollow egg for storing a small toy having a ridge circumscribing the egg. The egg is covered by an edible candy coating but the toy container is prevented from being embedded in the candy that encircles the toy container by the ridge which separates two candy coating into two halves. The ridge is not covered by the candy coating. These ridges are disclosed as including radially, outwardly extending portions having opposing side edges and an outer edge that encircles the surface of the egg. In one example, the ridge has right-angle edges which tend to rip foil wrapper covering the candy with typical variations in manufacturing or storage. The sharp cornered ridge may also scratch the skin or eye of a small child when the ridge is exposed from the candy coating.

Yet a further improvement on the concept of the outwardly extending rib was disclosed in the commonly assigned U.S. Pat. No. 8,859,024 to Gass, entitled “Separatable Shell for Receiving Candy Coating and Storing Toy” filed Nov. 21, 2009, the entire contents of which are incorporated herein by reference. One embodiment of the '024 Patent was the utilization of a circumscribing ridge with a rounded cross-section. Further embodiments limited the height of the ridge to the thickness of the chocolate.

Despite these prior developments improvements are desired. In particular improvements that address challenges faced following manufacture where the conditions the candy-coated toy containers are stored in are not closely controlled. Thus there remains a need for further candy-coated toy containers designed so as not to be embedded when coated with candy, and further, provides clear notice to a child that there is non-edible material below the candy coating. Additionally, there is a need to design a candy-coated container providing additional safety features.

### SUMMARY

In view of the foregoing, the present disclosure is directed to a container for a small toy that can be coated in food or candy without being embedded and provides clear notice to a child that non-edible material is located below the edible coating, contains few edges or right angles which might impact the foil wrapper.

A further aspect of the present disclosure provides relief for a candy-coating such that in the event the candy or food exceeds its melting point (e.g., during storage or shipment) space is provided to allow the candy-coating or food to flow without impacting the foil wrapper and further without obscuring or overcoming the components which provide the notice to the child (e.g., the ridge).

A further aspect of the present disclosure is directed to a ridge formed of a plurality of bollards. Each bollard has a substantially cylindrical shape. In some instances the bollards have a rounded top. The bollards may be formed into repeating patterns on a surface of the shell and may be placed in contact with each other or spaced from each other. The bollards may be formed in patterns to reveal a pleasing aesthetic and these patterns may provide the space for candy-coating to flow in the event of poor handling. The bollards may interlock with a portion being formed on each section of the shell to enable the separation into two equal halves along a join line of the shell halves. This interlock may provide an interference fit that can be overcome with the application of force by a child or other person seeking to separate the halves of the shell to reveal the toy or other treat located inside.

Another aspect of the present disclosure is directed to a container for a small toy having a ridge or lip that prevents the edible coating from embedding or completely covering the toy container so as to ensure a child is provided clear notice that non-edible material is below the edible coating. An additional aspect of the present disclosure is directed to a container having a ridge on the surface of the container with an outer curved surface to prevent cutting, puncturing or scraping the outer candy wrapper or the skin or eye of a child. This ridge may be formed of a plurality of bollards.

One aspect of the present disclosure is directed to a hollow container including a first section extending between a top end and a bottom end forming an exterior surface, an interior surface, and a rim defining an opening into an interior. The container includes a second section extending between a top end and a bottom end forming an exterior surface, and interior surface, and a rim defining an opening into an interior. Also included are a first bollard extending from a left side of the first section exterior surface adjacent the rim, and a second bollard extending from a left side the second section exterior surface adjacent the rim; wherein the first section and the second section are releasably connected at their openings forming a sealed container with a midsection disposed between the first section and second section, and wherein the first bollard is disposed adjacent the second bollard at the midsection.

The container may include a first candy coating on the first section and a second candy coating on the second section, and optionally a covering about the exterior of the first and second confectionary coating.

In accordance with one aspect of the disclosure the first bollard and the second bollard have a generally rectangular cross-section and terminate at an outer edge; and the outer edge is generally parallel with the exterior surface of the candy coating. The first bollard and the second bollard may have a circular cross-section. Or the first bollard and the second bollard may be spherical. Or the first bollard and the second bollard may be tubular.

The container may include a plurality of widely spaced bollards on the first and second halves along a plane extending longitudinally through the container. The midsection may be along a plane extending longitudinally through the container and includes a third bollard extending from the first section exterior surface adjacent the rim at the top end, and a fourth bollard extending from the second section exterior surface adjacent the rim at the bottom end, wherein the third bollard is widely spaced from the first bollard, and the fourth bollard is widely spaced from the second bollard. The third bollard may be adjacent the top end and the fourth bollard may be adjacent the bottom end. The third bollard may extend from the top end and the fourth bollard extends from the bottom end.

In accordance with a further aspect of the present disclosure the container includes a midsection along a plane extending longitudinally through the container and a third bollard extending from the first section exterior surface adjacent the top end. The container may further include a fourth bollard extending from the second section exterior surface adjacent the top end; wherein the third bollard is disposed adjacent the fourth bollard when the first section and second section are connected and wherein the third bollard is widely spaced from the first bollard, and the fourth bollard is widely spaced from the second bollard. The third bollard and the fourth bollard may both have a circular cross-section.

In accordance with the present disclosure, the midsection is along a plane extending transversely through the container, the first section rim includes an opening at the left side. The second bollard forms a lower extension, and the lower extension is disposed within the opening when the first section and second section are connected at their openings. The first section flange may be formed at the first section opening and include an interior surface forming an upper groove and a lower groove, wherein the upper groove is interrupted by the first section gap, and a second section flange formed at the second section opening, including an exterior surface forming an upper ridge and a lower ridge and wherein the upper ridge is interrupted by the lower extension.

In accordance with the present disclosure, the container includes a first confectionary coating at the exterior of the container covering section of the container and forming an edge and a second confectionary coating at the exterior of the container covering section of the container and forming a second edge adjacent the first edge, wherein the first and second bollards are disposed between the first and second confectionary coatings, and a covering about the exterior of the first and second confectionary coatings.

A further aspect of the present disclosure is directed to a hollow container including a first section extending between a bottom end and a top end forming an upwardly open container having an exterior surface, an interior surface, and a rim at the top end defining an opening into an interior. The container also includes a first flange formed at the first section opening, comprising an interior surface forming an upper groove, a lower groove, and an opening interrupting the upper groove. The container includes a second section extending between a top end and a bottom end forming a downwardly open container having an exterior surface, an interior surface, and a rim at the bottom end defining an opening into an interior. A second flange is formed at the second section opening, comprising an exterior surface forming an upper ridge and a lower ridge. A first bollard extends from the first section exterior surface adjacent the rim forming a bottom to the gap. A second bollard extends from the second section exterior surface adjacent the rim forming a lower extension interrupting the upper ridge, wherein the first section and the second section are releasably connected at their openings forming a sealed container with a midsection disposed between the first section top end and second bottom top end, whereupon the first bollard is received within the gap.

The container may include a longitudinal plane extending through the first bollard, a first coating at the exterior of the container covering the first section and the second section forming an edge adjacent the longitudinal plane, and a second candy coating at the exterior of the container covering the first section and the second section forming an edge adjacent the longitudinal plane, wherein the first and second bollards are disposed along the plane between the first and second candy coatings. The container may further include a covering about the exterior of the first and second candy coatings. The container may include a plane extending through the first bollard, a third bollard extending from the first section exterior surface at the bottom end, and a fourth bollard extending from the second section exterior surface at the top end, wherein the first, second, third, and fourth bollards are disposed along the plane, and wherein the third bollard is widely spaced from the first bollard, and the fourth bollard is widely spaced from the second bollard.

A further aspect of the present disclosure is directed to a container having a longitudinal axis greater than a transverse axis. The container includes a first section extending between a top end and a bottom end forming an exterior surface, an interior surface, and a rim defining an opening into an interior and a second section extending between a top end and a bottom end forming an exterior surface, and interior surface, and a rim defining an opening into an interior. The container includes a first bollard extending from a left side of the first section exterior surface adjacent the rim, and a second bollard extending from a left side the second section exterior surface adjacent the rim. The first section and the second section are releasably connected at their openings forming a sealed container with a midsection disposed between the first section and second section, and wherein the first bollard is opposite the second bollard at the midsection. A first candy coating at the exterior of the container covers the first section and the second section forming an edge adjacent a longitudinal plane extending through the longitudinal axis and the left side and a second candy coating at the exterior of the container covering the first section and the second section forming an edge adjacent the longitudinal plane, wherein the first and second bollards are disposed along the longitudinal plane between the first and second confectionary coatings; and a covering about the exterior of the first and second confectionary coatings.

The container may include a plurality of widely spaced bollards at the exterior of the first and second halves aligned along the longitudinal plane extending through the longitudinal axis and the left side. The first section rim forms an opening at the left side, the second bollard forms a lower extension, and the lower extension is disposed within the gap when the first section and second section are connected by their openings. The first section flange may be formed at the first section opening, comprising an interior surface forming an upper groove and a lower groove wherein the upper groove is interrupted by the first section opening, and a second section flange formed at the second section opening, comprising an exterior surface forming an upper ridge and a lower ridge; and wherein the upper ridge is interrupted by the lower extension. The container may further include an object disposed within the first section and second section interior.

### BRIEF DESCRIPTION OF THE DRAWINGS

FIG. 1 is a profile view of a container in accordance with the present disclosure;

FIG. 2A is a cross-sectional view of a locking mechanism for a container in accordance with the present disclosure;

FIG. 2B is a cross-sectional view of an alternative locking mechanism for a container in accordance with the present disclosure;

FIG. 2C is a top view of a further locking mechanism according to the present disclosure;

FIG. 3A is side view of a ridge in accordance with the present disclosure;

FIG. 3B is a top view of a ridge in accordance with the present disclosure;

FIG. 4A is a profile view of a container in accordance with the present disclosure;

FIG. 4B is a top view of a ridge in accordance with the embodiment of FIG. 4A and in accordance with the present disclosure;

FIG. 5A is a profile view of another container in accordance with the present disclosure;

FIG. 5B is a top view of a ridge in accordance with the embodiment of FIG. 5A and in accordance with the present disclosure;

FIGS. 6A and 6B are profile views of further containers in accordance with the present disclosure;

FIG. 7A is a top view of a ridge in accordance with the present disclosure;

FIG. 7B is a plan view of a container section depicting a bollard arrangement in accordance with the present disclosure;

FIG. 7C is a plan view of a second container section depicting a bollard arrangement in accordance with the present disclosure;

FIG. 8 is a perspective view of a container in accordance with the present disclosure having a hinge;

FIG. 9 is a profile view of a variety of bollards in accordance with the present disclosure;

FIGS. 10A and 10B are top views of ridges using rectangular bollards in accordance with present disclosure;

FIG. 10C is a top view of a ridge depicting a bollard arrangement in accordance with the present disclosure;

FIG. 10D is a cross-sectional view of FIG. 10C;

FIG. 10E is a top view of a ridge depicting a bollard arrangement in accordance with the present disclosure;

FIG. 11A is a top view of a ridge formed of a sinusoidal waveform in accordance with the present disclosure;

FIG. 11B is a cross sectional view of a ridge formed of a sinusoidal waveform in accordance with the present disclosure;

FIG. 12 is a top view of a ridge formed of a trapezoidal waveform in accordance with the present disclosure; and

FIGS. 13A-13D are side views of ridges using bollards depicted in FIG. 9 in accordance with the present disclosure.

### DETAILED DESCRIPTION

The present disclosure is directed to improvements in separable containers. Specifically, the present disclosure is directed to a hollow container that is separable into two pieces and may include a toy or other item inside. Further, the container is coated with a candy-coating and the halves of the candy-coating are separated by regulatory compliant ridges formed of a plurality of bollards. These and other features of the present disclosure are described in greater detail below.

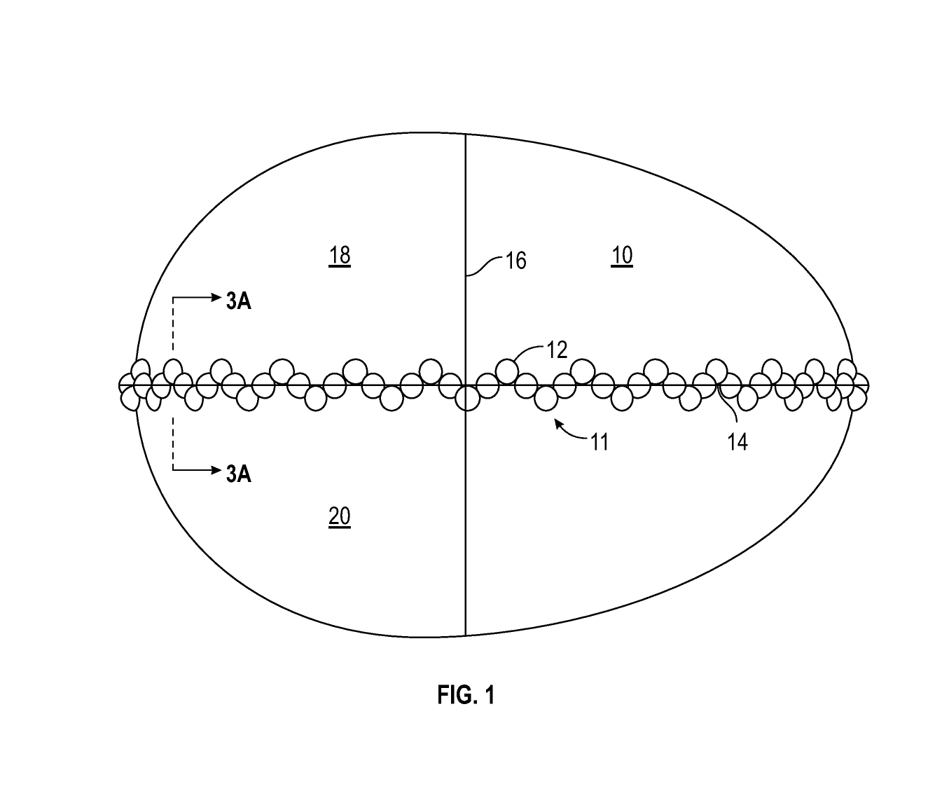

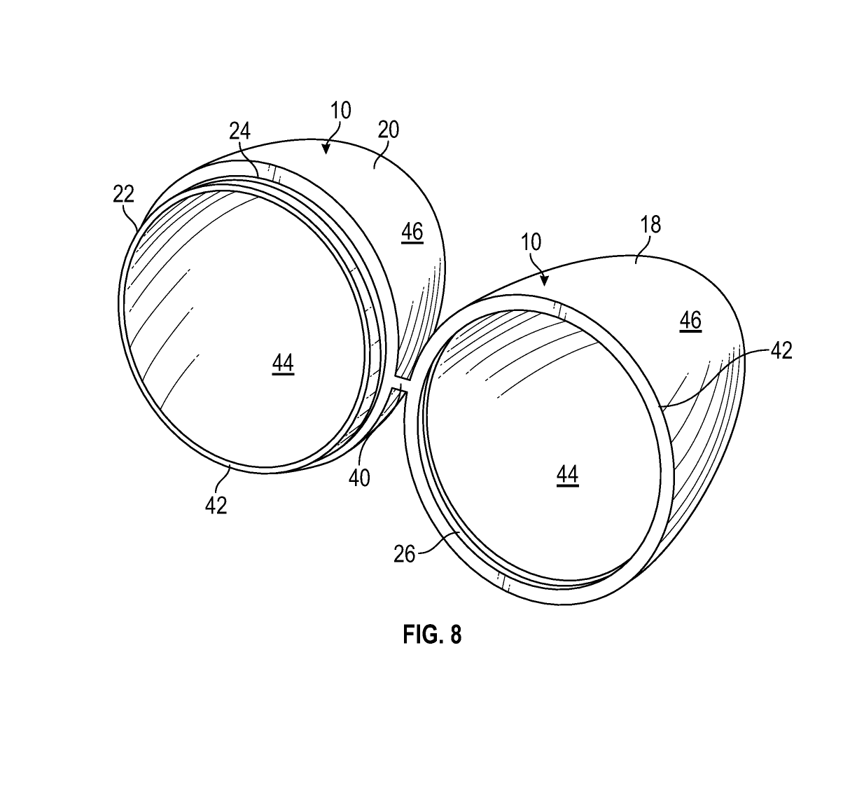

FIG. 1 depicts a side view of a container 10, formed in a generally egg shape. The container 10 includes a plurality of bollards 12 formed in a repeating three up and down pattern ridge 11. In the example in FIG. 1 the bollards are formed along a longitudinal axis 14, however, the bollards could also be formed along the transverse axis 16. Either the longitudinal axis 14 or the transverse axis 16 may separate the container 10 into two halves 18, 20 as depicted in FIG. 8. Further, the bollards 12 may be formed at an angle to longitudinal axis 14 and the transverse axis 16. The container has two halves 18 and 20, which may be joined together.

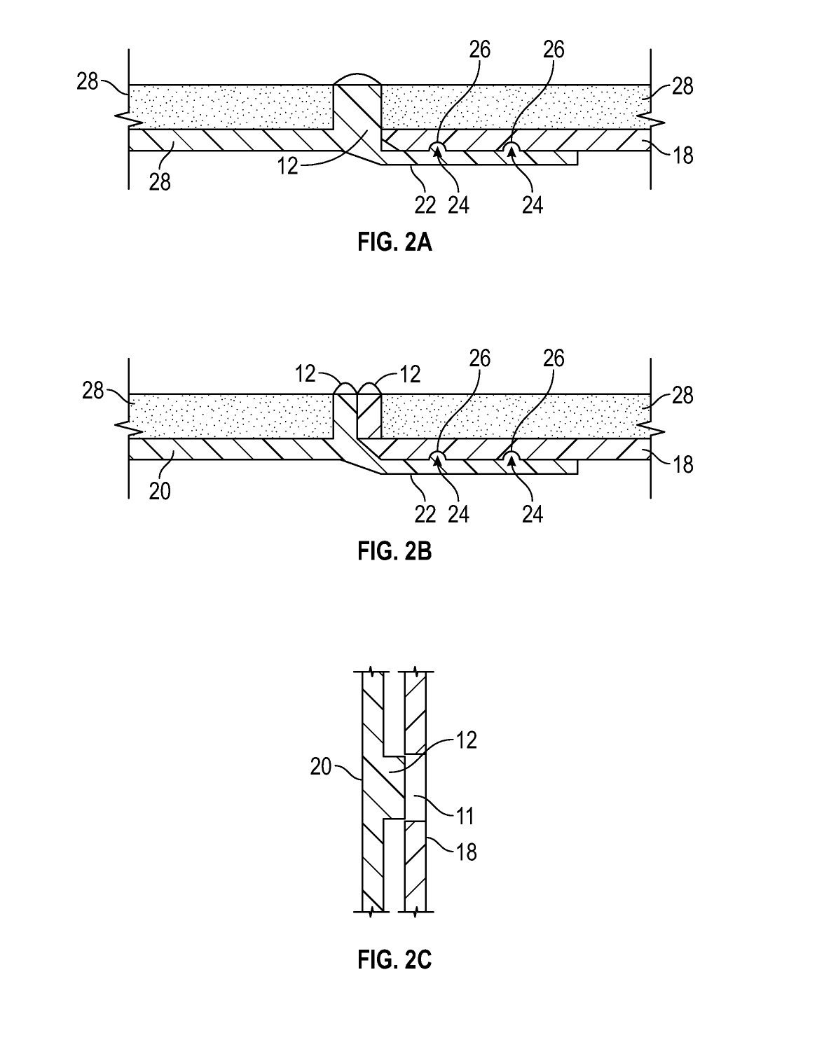

FIG. 2A shows a detailed cross-sectional view of the two halves 18 and 20 joined together. In his example, the bollard 12 in FIG. 2A is formed just on one of the section 20, which interlocks with the second section 18. Container section 20 includes an interlock projection 22, which has a smaller radius than the remainder of the sidewall of the container section 20 and of the sidewall of container section 18 such that when joined together the interlock projection 22 fits inside the container section 18. The interlock projection 22 includes two nubs 24 which mate with two recesses 26 formed on the container section 18. These nubs 24 and recesses 26 mate to provide resistance to separation of the two container halves 18 and 20 and provide a sturdy platform for the candy-coating 28 applied to the both halves 18 and 20 of the container 10, after being brought together. FIG. 2A depicts a rounded end of bollard 12 as it would appear in one example of cross-section. As can be appreciated the bollard 12 may be formed on either section 18, 20 of the container 10, or be formed of one or more bollards 12 (or partial bollards) formed on both halves 18 and 20, which align when the two halves are brought together as depicted in FIG. 2B. Still further, the bollard 12 may be received in an opening 11 formed in the first section 18 to provide alternative means for securing the two halves 18, 20 to one another either alone or in combination with the nubs 24 and recesses 26, as shown in FIG. 2C. The bollard 12 formed on section 18 may include an extension 13, formed on the section 20, which when brought together form a complete bollard 12.

The nubs 24, shown in profile in FIG. 2A, may in fact be ridges which circumscribe the interlock projection 22 forming continuous ridges, which are received in the recesses 26, which circumscribe an inner surface of the container section 18. In instances where the bollard 12 is received into an opening formed in the container section 18, the opening may extend through one or both of the ridges formed of nubs 24.

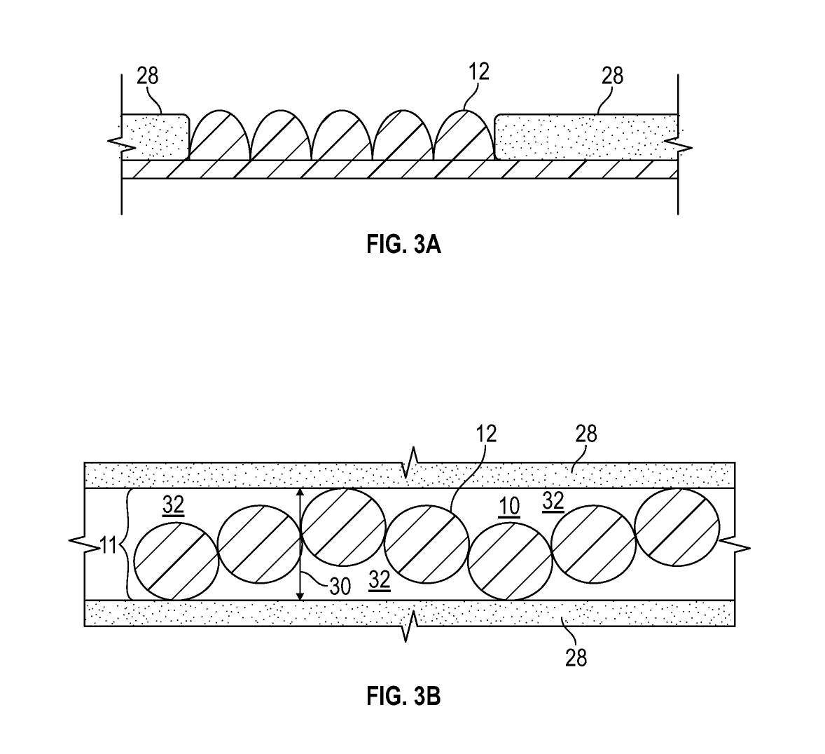

FIG. 3A depicts a side view of the further aspect of the design of container 10. Specifically FIG. 3A shows the side view of the bollards 12 of ridge 11. The bollards 12 form a ridge 11 separating the two candy-coating 28. FIG. 3B depicts a top view of the ridge 11 and bollards 12 separating the candy-coatings 28. FIG. 3B makes clear that the candy-coatings 28 are separated be the entire width dimension 30 of the multi-bollard arrangement. The candy-coatings are generally formed separate from the container 10, and thus can be appropriately dimensioned such that they do not extend closer to one another once applied to the container 10 than the width dimension 30 of ridge 11. This width dimension 30 of ridge 11 allows for the bollards 12 and a portion of the shell 10 to be clearly visible to an individual handling the assembly and meet the regulatory requirements described herein.

In addition to meeting these regulatory requirements, the arrangement of the bollards depicted in FIG. 3A also demonstrate a further feature of the present disclosure, namely melt receptacles 32. These melt receptacles 32 provide a location for the candy-coating to flow when its viscosity drops, for example by improper storage above a candy melt point. Previously disclosed ridges have been of a uniform width and circumscribe the shell with the candy-coating directly abutting the ridge. In contrast, by separating the candy-coatings 28 at least in certain portions of the ridge 11, if the viscosity of the candy-coating is to drop such that it can begin to flow, the receptacles 32 provide a location to collect the candy-coating 28. These receptacles 32 can collect this flowing candy-coating 28 and still maintain clear separation of the candy-coatings 28 with the visibility of the bollards remaining intact thus meeting the regulatory visibility requirements.

Further, the receptacles 32 provide a pressure relief on any foil covering the candy-coated assembly. Prior ridge arrangements forced the candy-coating into the foil when there was any melting. This resulted in unsightly and unappetizing forcing of the candy coating through the foil wrapper and in some instances the need to discard the entire assembly. By providing receptacles 32, there is an unimpeded path for the candy-coating to flow without putting any pressure on the foil wrapper. The result is a product that outwardly shows no effects from improper handling. Further, once the handling returns to proper technique and the candy-coating is allowed to re-harden with limited discernible effects.

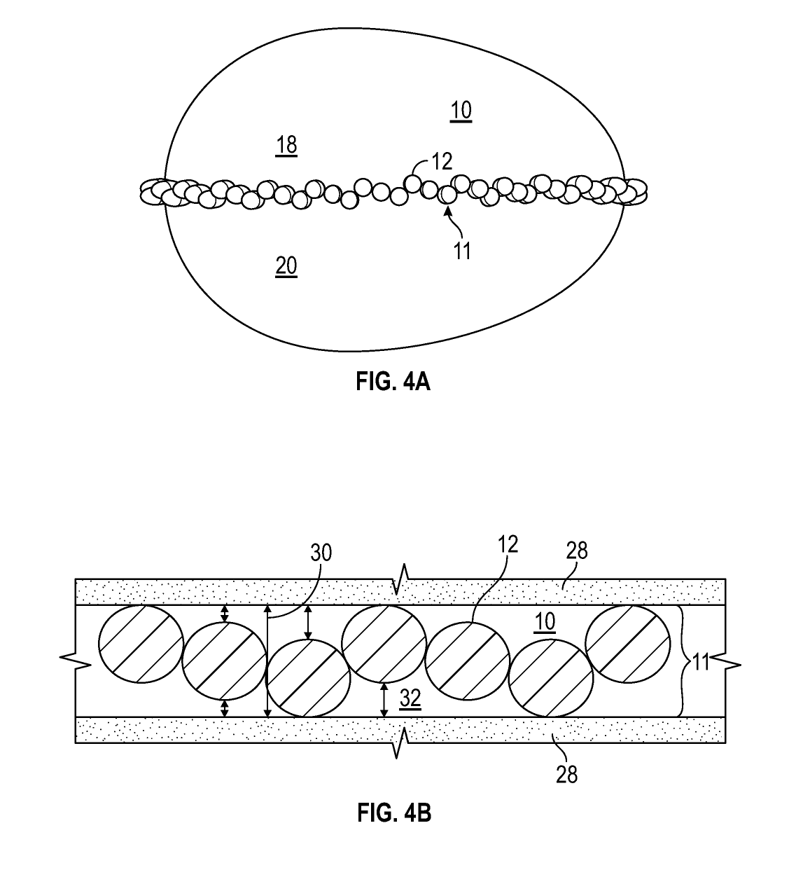

FIGS. 4A and 4B depict a further arrangement of the bollards 12 of ridge 11. In FIGS. 4A and 4B the bollards 12 are arranged in a repeating three down-two up pattern. In some embodiments this arrangement might be preferred because the dimension 30 is somewhat less than the dimension 30 in the embodiment of FIGS. 3A and 3B. All other features of FIGS. 4A and 4B are similar to those described with respect to FIGS. 1-3B above.

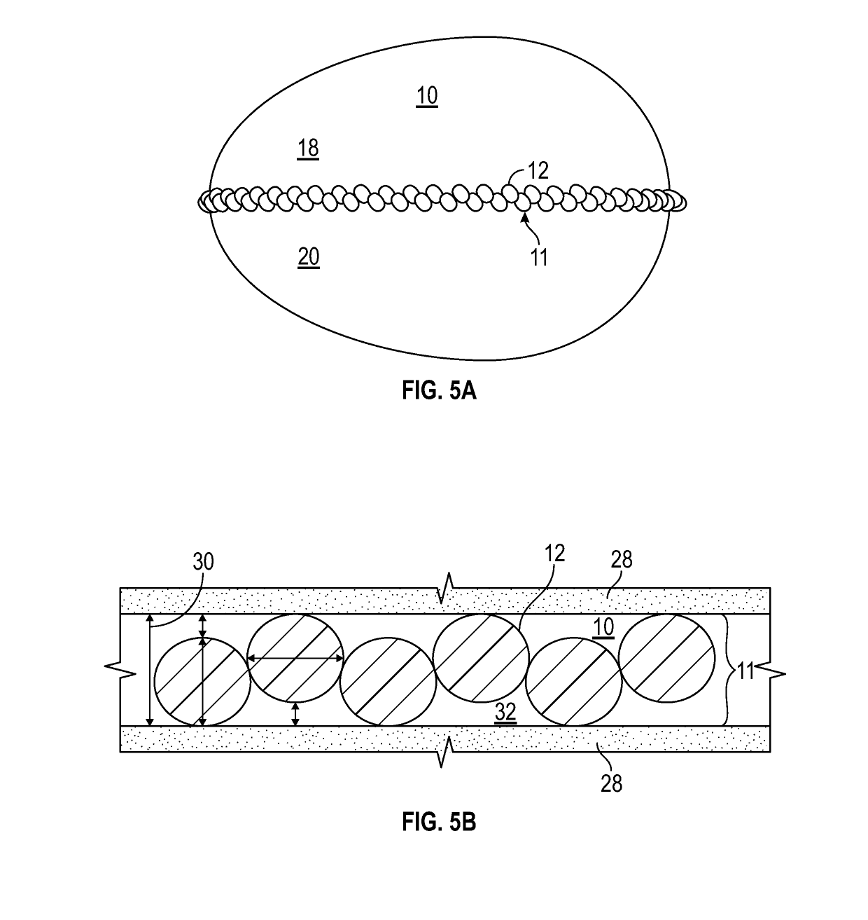

FIGS. 5A and 5B depict a further arrangement of the bollards 12 of ridge 11. In FIGS. 5A and 5B, the bollards 12 are arranged in a repeating one up one down patter. In some embodiments this arrangement might be preferred because the dimension 30 is somewhat less than the dimension 30 in the embodiments of FIGS. 3A-4B. All other features of FIGS. 4A and 4B are similar to those described with respect to FIGS. 1-3B above. A further aspect of the arrangement as depicted in FIGS. 5A and 5B is that the bollards 12 may be formed on container halves 18 and 20 in an alternating and interlocking arrangement. That is that every other bollard 12 is formed on container section 18 and mates with alternately formed bollards 12 formed on container section 20. Such an arrangement can be used to obviate the need for forming interlock projection 22 on one of the container halves 18 or 20 and can provide a more aesthetically appealing container, particularly when opened and the container halves are separated.

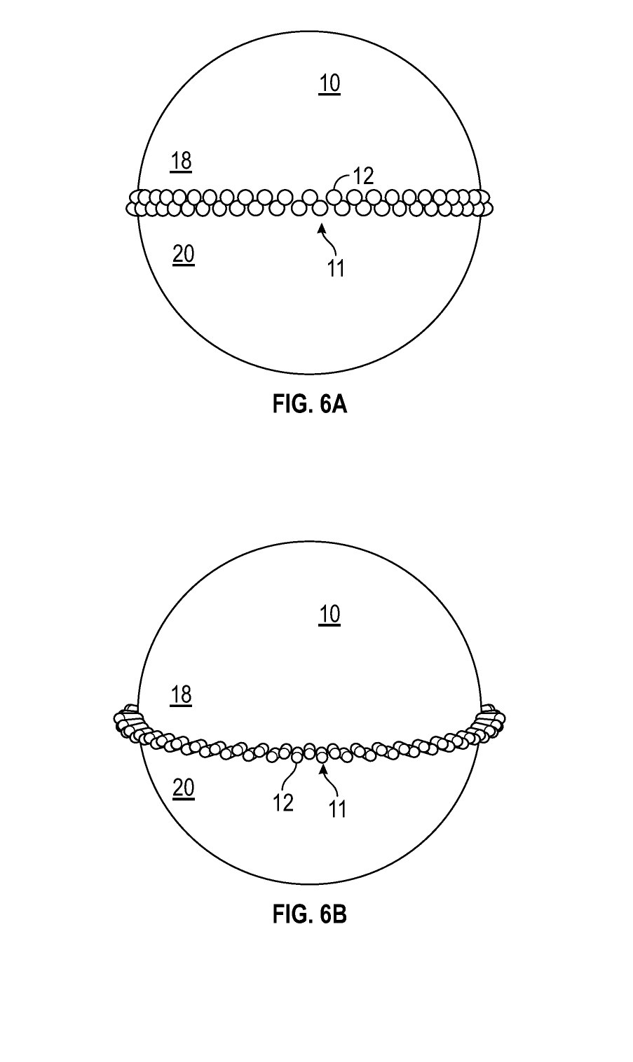

FIGS. 6A and 6B show two further arrangements of the one up-one down bollard 12 configuration. In both FIGS. 6A and 6B the bollards 12 are formed on spherical containers 10 as opposed to egg shaped containers 10 as depicted in FIGS. 1-5B. Indeed, nearly any shaped container 10 can be used in accordance with the present disclosure including rectangular, spherical, oblong, and even character or object shaped. For example famous cartoon figure or historical figure shaped containers 10 may be formed and candy-coated in accordance with the present disclosure. Further, FIGS. 6A and 6B show that the relative locations of the bollards 12 may be altered in accordance with the desires of the manufacturer or seller. In FIG. 6A, a thicker ridge 11 is formed where the centerline of the bollards is placed close together and requiring more bollards 12 to circumscribe the container 10. In FIG. 6B a narrower ridge 11 is formed with the centerlines of the bollards spaced further from each other and thus fewer bollards 12 are need to circumscribe the container 10. In addition FIG. 6B shows that the vertical dimension of the bollards 12, that is the distance the bollards project from the container 12 can be varied as desired. In FIG. 6B the bollards project further away, have a greater height, than the bollards 12 of FIG. 6A.

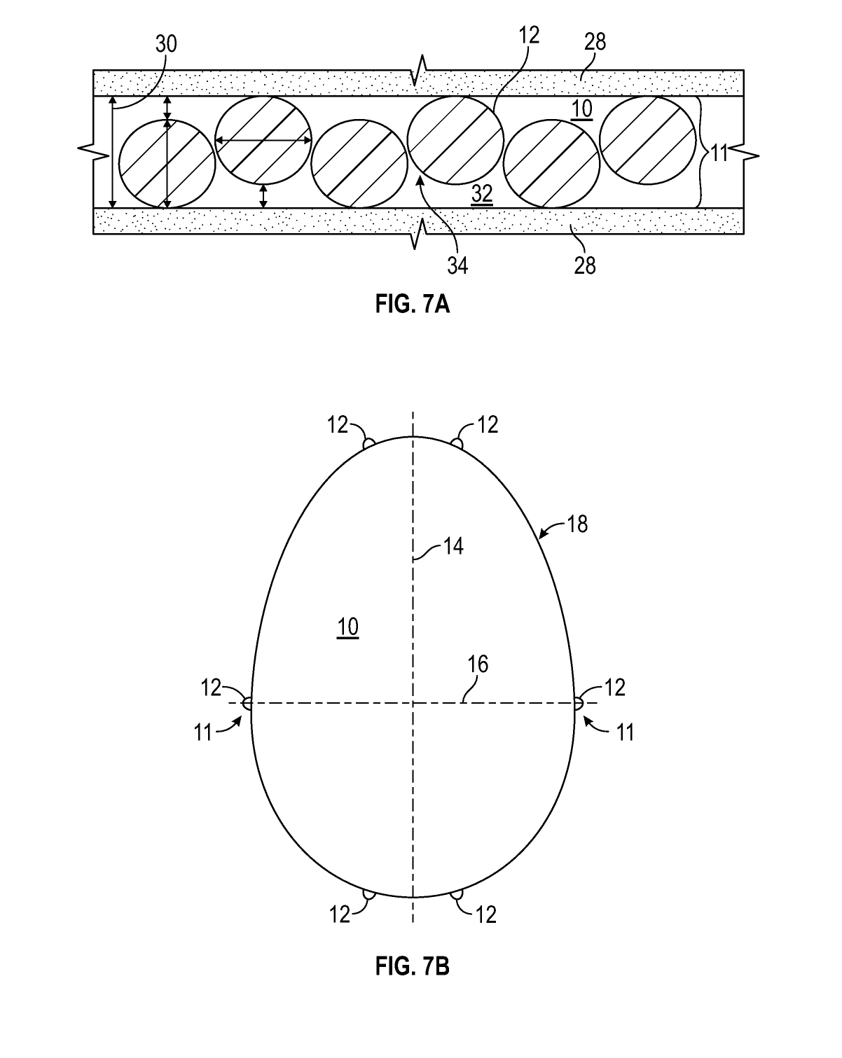

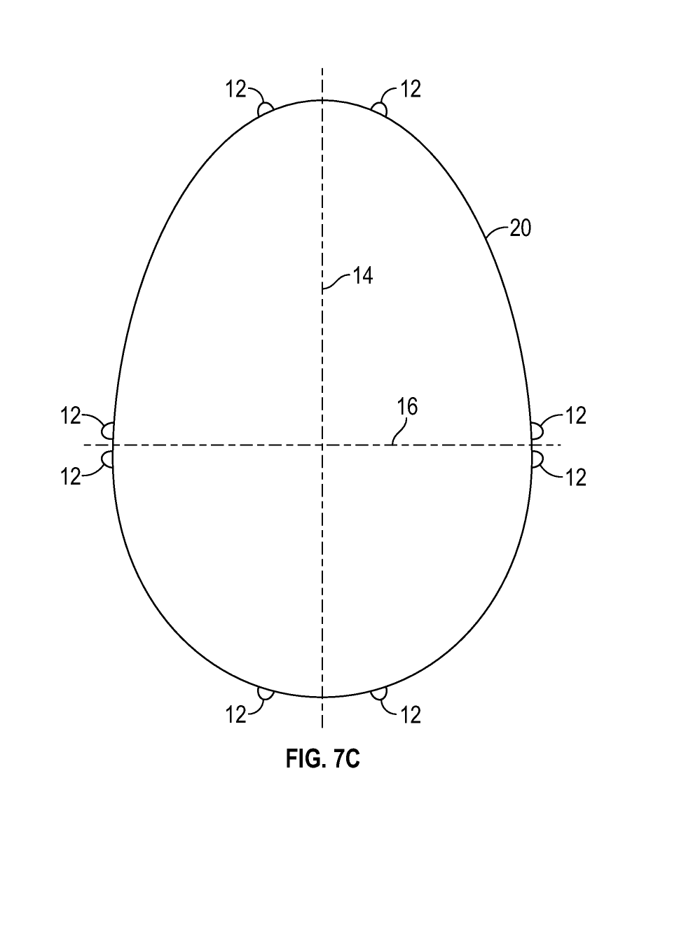

The embodiments of FIGS. 1-6B have depicted the bollards 12 in contact with one another. That is each bollard 12 is in contact with the bollards on either side of it thus creating a solid or continuous ridge 11 that circumscribes the container 10 and definitively separating the container halves 18 and 20. According to an embodiment depicted in FIG. 7A, the bollards 12 may be slightly separated from one another. While no longer in contact the ridge 11 is still continuously formed around the circumference of the container 10. One advantage of the separated bollards is that it provides for channels 34 that allow candy-coating that has become viscous or has melted to flow through to the other side of the ridge 11. As with the embodiments above having just the receptacles 32, the flowing of the candy-coating to the other side of the ridge helps to ensure that the bollards 12 remain visible to someone handling the assembly (thus satisfying the regulatory requirements) and limiting the opportunity for the candy-coating to put pressure on any foil wrapper.

Taken to the extreme this ridge 11 of non-contacting bollards 12 may be as little as a pair of bollards 12 formed on opposite sides of the container 10 along the transverse axis 16. For example, in an egg shape as shown in FIG. 7B, a single bollard 12 may be formed on each side of the container section 18. Alternatively, the bollards 12 may be placed at intervals to ensure that the candy coating 28 does not fully encompass the container 10. In FIG. 7B bollards 12 are also shown placed at four locations on the periphery of a section 18 of the container 10 along with at the transverse axis 14. FIG. 7C depicts a similar arrangement of the bollards 12 at locations on the section 20 of container 10 such that when brought together, the bollards 12 on section 18 is offset from the bollards 12 on the section 20 of the container 10. Though depicted in FIG. 7C as having two bollards 12 on either side of the transverse axis 14, only one such bollard 12 may be used in certain embodiments. Further, though the bollard 12 is depicted on the transverse axis 14 in FIG. 7B, the bollard 12 may be placed above or below the axis 14 without departing from the scope of the present disclosure.

A further aspect of the present disclosure is depicted in FIG. 8, where the container 10 and specifically the two container halves 18 and 20 are connected to one another via a hinge 40. The hinge 40 may be formed of a flexible material and prevent the two halves 18 and 20 from being easily separated from one another when the container 10 is opened. Though depicted without the ridge 11, in accordance with the present disclosure a ridge 11 can be formed either circumferentially around the opening 42 of the container 10 or alternatively, perpendicularly to the opening 42. Further, the ridge 11 may be formed at an angle to the opening 42 (e.g. diagonally with respect to the opening). The addition of the hinge 40 further enhances the safety aspects of the design, by increasing the size of the container 10 even when in the opened configuration (as shown in FIG. 8) thus making it that much harder to inadvertently ingest. As depicted in FIG. 8, the nubs 24 formed on interlock projection 22, made with the recesses 26 to secure the container halves 18 and 20. The halves 18 and 20 each define an interior surface 44 an exterior surface 46.

As can be appreciated, the bollards 12 as described herein may take on nearly any configuration. The primary objectives of the bollards 12 is to form a separation between halves of the candy coatings 28 and to provide a visual indicator to anyone handing the assembly that there are other components beneath the candy coating 28. In addition, though described with reference to a single candy coating 28, those of skill in the art will understand that each section of 18, 20 of the container may receive its own candy coating 28. Further each candy coating 28, may in fact be made of a number of such coatings layered on one another without departing from the scope of the present disclosure. Further, FIG. 9 provides a variety of non-limiting bollard styles in both a contacting and separated configuration. Any of these may be used in combination with the above described embodiments of FIGS. 1-8.

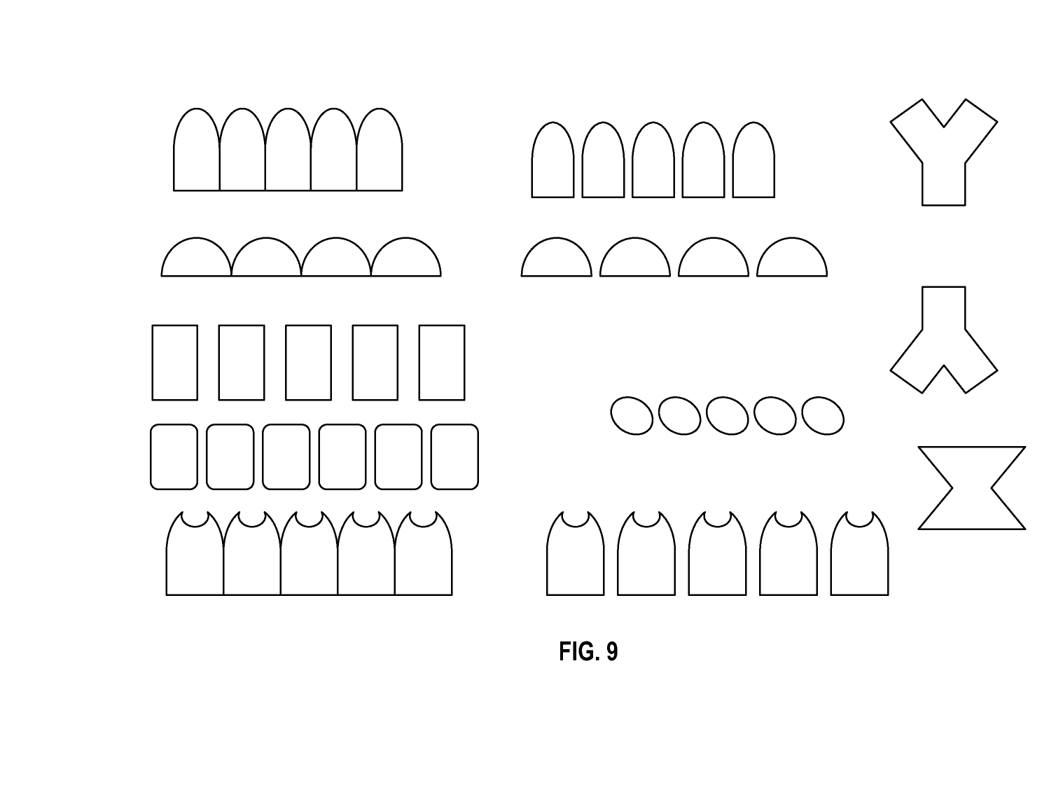

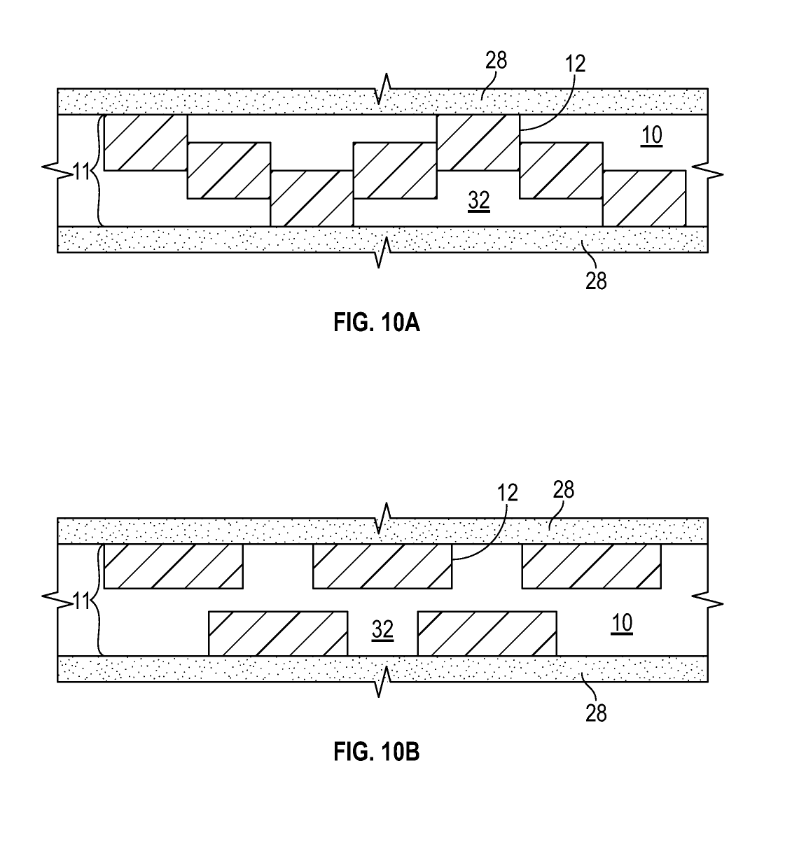

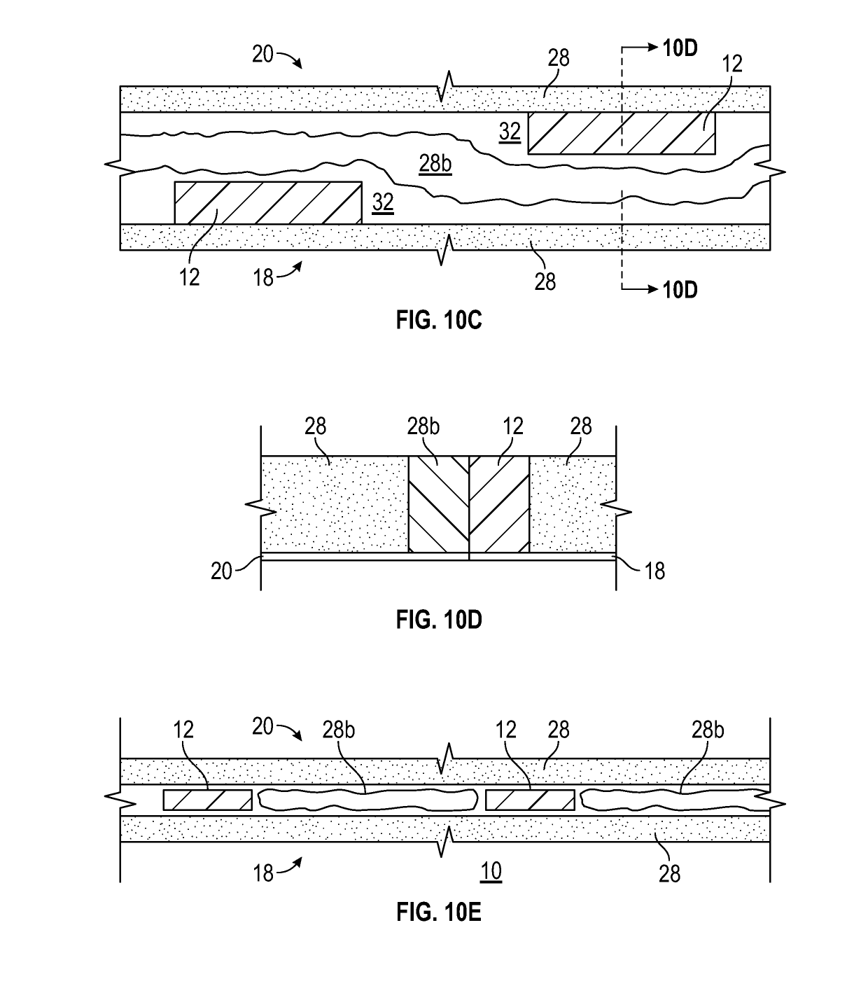

FIG. 10A depicts an overhead view of a ridge 11 utilizing rectangular bollards 12 in a contacting arrangement similar to FIG. 1. FIG. 10B depicts an overhead view of a ridge 11 utilizing rectangular bollards 12 in a non-contacting arrangement similar to FIG. 7.

In a further embodiment, in the receptacles 32 provide a location for further application of candy coating 28 after joining the two halves 18, 20 (FIG. 2). An example of this can be seen in FIG. 10C, a second application of candy coating 28b is deposited between the rectangular bollards 12 in receptacles 32. This second application of candy coating 28b may be formed of molten candy coating and applied in molten form to the receptacle 32 after the joining of the two halves 18 and 20 and the application of the candy coating 28 to each section. This second application of candy coating 28b provides for a more visually pleasing appearance of the final product and also helps to create a uniform surface by the candy coating 28, bollards 12, and second application of candy coating 28b, such that upon application of a foil wrapper there is no difference in height of the product being wrapped. This can be seen in the cross-section view of FIG. 10D. The one requirement is that the bollards 12 remain visible to a user in compliance with the regulations. Though shown in FIG. 10C as having bollards 12 formed alternately on halves 18 and 20 or container 10, all bollards 12 may be formed on one of halves 18 or 20, without departing from the scope of the present disclosure. FIG. 10E provides a further alterative view of the spaced bollards 12.

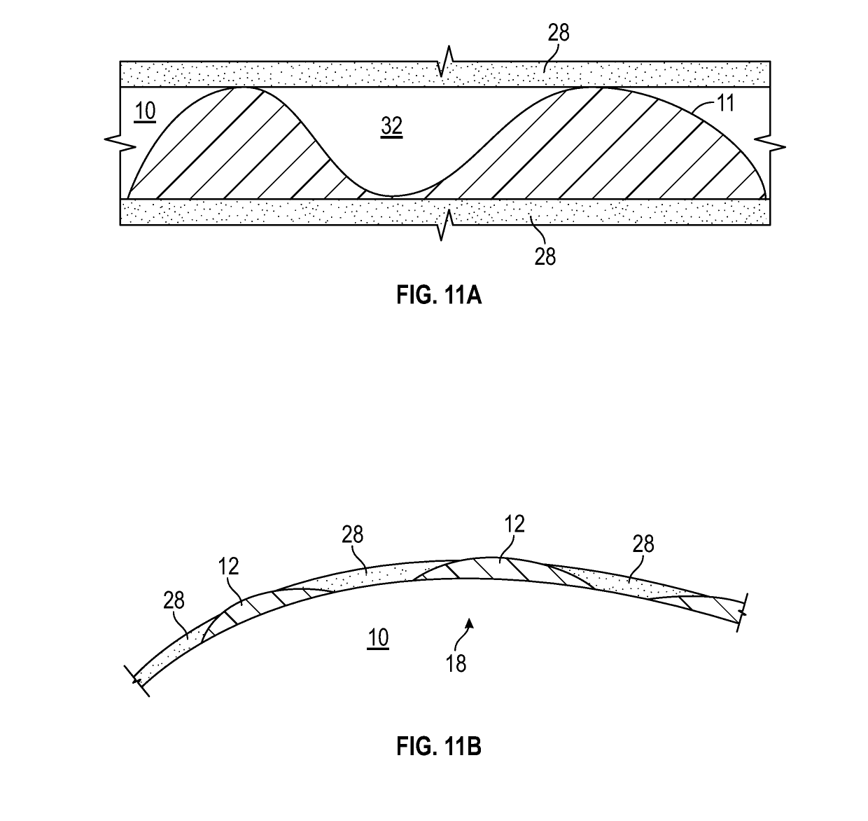

FIG. 11 depicts a further overhead view of another embodiment of the present disclosure wherein the ridge 11 is somewhat larger and is formed in a sinusoidal wave pattern. Though depicted as a section-sinusoidal pattern with receptacles 32 formed on just one side of the container 10, it is contemplated that a complete sinusoidal ridge 11 could be employed where alternating receptacles 32 are formed.

FIG. 11B depicts an alternative sinusoidal where the ridge 11 rather than being transverse across the distance between the candy coating 28 forming receptacles 32, has a varying height from the surface of the shell 10.

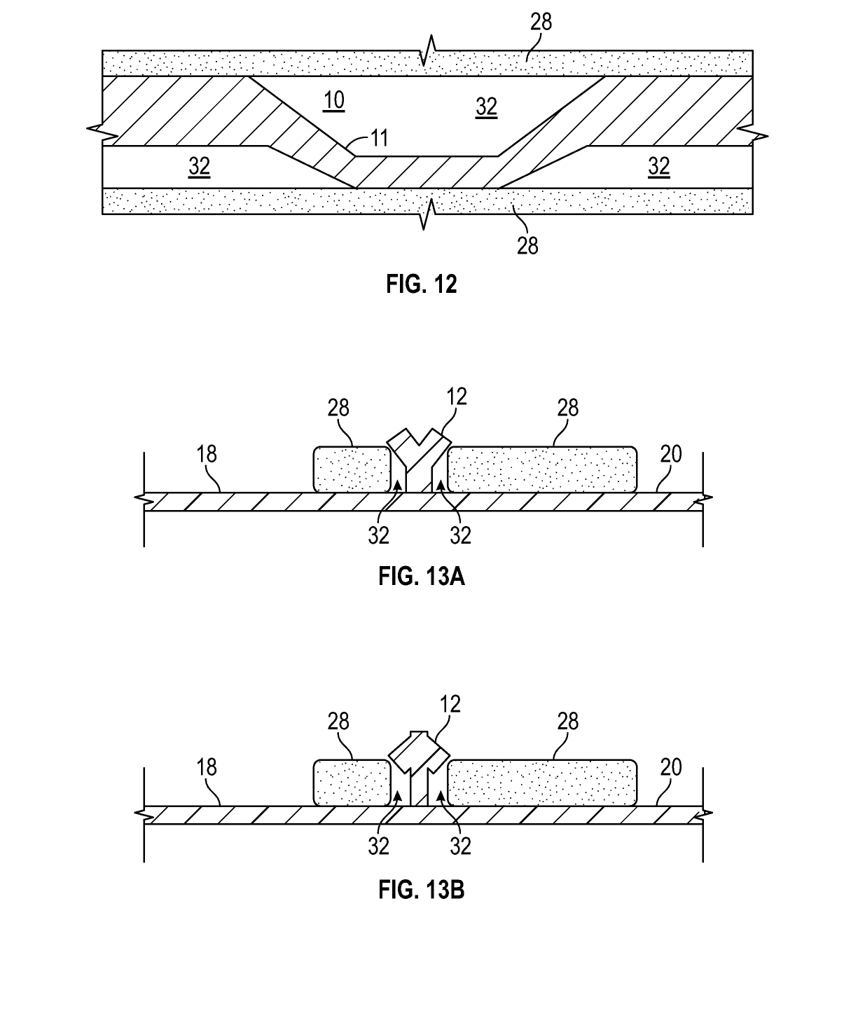

FIG. 12 depicts yet another overhead view of a continuous ridge 11. As with FIG. 11 this also a wave form shaped ridge 11 but a trapezoidal wave form rather than a sinusoidal wave form. Receptacles 32 are formed on both sides of the ridge 11.

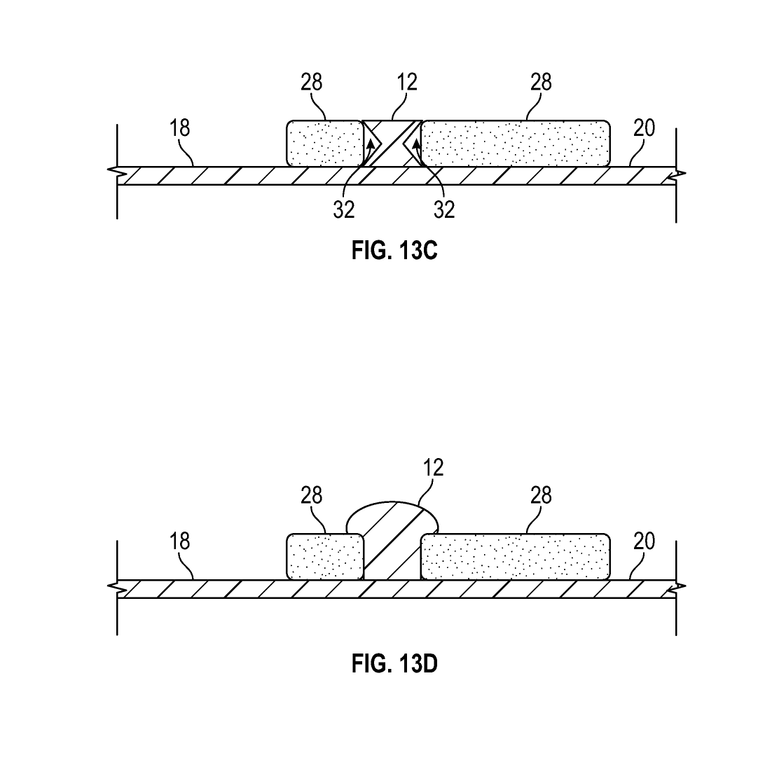

FIGS. 13A-13D depict side views of ridges 11 formed of some of the bollards depicted in FIG. 9. In each instances the ridge is formed of a bollard 12 and includes receptacles 32 formed on either side of the bollard. FIG. 13A shows a Y-shaped bollard 12. FIG. 13B shows an arrow-shaped bollard 12. FIG. 13C shows an X-shaped bollard 12 and FIG. 13D shows a mushroom-shaped bollard 12.

The disclosure has been given by way of example only, and various other modifications of and/or alterations to the described embodiment may be made by persons skilled in the art without departing from the scope of the disclosure as specified in the appended claims. Any embodiment described herein may be used alone or in conjunction with the features and aspects of any other embodiment without departing from the scope of the present disclosure.

I claim:

1. A hollow container, comprising:
a first section extending between a top end and a bottom end forming an exterior surface, an interior surface, and a rim defining an opening into an interior;
a second section extending between a top end and a bottom end forming an exterior surface, and interior surface, and a rim defining an opening into an interior;
a first bollard extending from a left side of the first section exterior surface adjacent the rim;
a second bollard extending from a left side the second section exterior surface adjacent the rim, wherein the first section and the second section are releasably connected at their openings forming a sealed container with a midsection disposed between the first section and second section, and wherein the first bollard is disposed adjacent the second bollard at the midsection.

2. The container of claim 1, further comprising: a first candy coating on the first section, and a second candy coating on the second section.

3. The container of claim 2, further comprising a covering about the exterior of the first and second confectionary coating.

4. The container of claim 1, wherein the first bollard and the second bollard have a generally rectangular cross-section.

5. The container of claim 4, wherein the first and second bollards terminate at an outer edge; and the outer edge is generally parallel with the exterior surface of the candy coating.

6. The container of claim 1, wherein the first bollard and the second bollard have a circular cross-section.

7. The container of claim 6, wherein the first bollard and the second bollard are spherical.

8. The container of claim 6, wherein the first bollard and the second bollard are tubular.

9. The container of claim 1, further comprising a plurality of widely spaced bollards on the first and second halves along a plane extending longitudinally through the container.

10. The container of claim 1, wherein the midsection is along a plane extending longitudinally through the container and further comprising:
a third bollard extending from the first section exterior surface adjacent the rim at the top end; and
a fourth bollard extending from the second section exterior surface adjacent the rim at the bottom end,
wherein the third bollard is widely spaced from the first bollard, and the fourth bollard is widely spaced from the second bollard.

11. The container of claim 10, wherein the third bollard is adjacent the top end; and the fourth bollard is adjacent the bottom end.

12. The container of claim 10, wherein the third bollard extends from the top end; and the fourth bollard extends from the bottom end.

13. The container of claim 1, wherein the midsection is along a plane extending longitudinally
through the container and further comprising:
a third bollard extending from the first section exterior surface adjacent the top end;
a fourth bollard extending from the second section exterior surface adjacent the top end; wherein the third bollard is disposed adjacent the fourth bollard when the first section and second section are connected and wherein the third bollard is widely spaced from the first bollard, and the fourth bollard is widely spaced from the second bollard.

14. The container of claim 13, wherein the third bollard and the fourth bollard have a circular cross-section.

15. The container of claim 1, wherein the midsection is along a plane extending transversely through the container, the first section rim includes an opening, the second bollard forms a lower extension, and the lower extension is disposed within the opening when the first section and second section are connected at their openings.

16. The container of claim 15, further comprising:
a first section flange formed at the first section opening, comprising an interior surface forming an upper groove and a lower groove, wherein the upper groove is interrupted by the first section rim opening; and
a second section flange formed at the second section opening, comprising an exterior surface forming an upper ridge and a lower ridge and wherein the upper ridge is interrupted by the lower extension.

17. The container of claim 1, further comprising:
a first confectionary coating at the exterior of the container covering section of the container and forming a first edge adjacent;
a second confectionary coating at the exterior of the container covering section of the container and forming a second edge adjacent the first edge, wherein the first and second bollards are disposed between the first and second confectionary coatings; and
a covering about the exterior of the first and second confectionary coatings.

18. A hollow container, comprising:
a first section extending between a bottom end and a top end forming an upwardly open container having an exterior surface, an interior surface, and a rim at the top end defining an opening into an interior;
a first flange formed at the first section opening, comprising an interior surface forming an upper groove, a lower groove, and an opening interrupting the upper groove;
a second section extending between a top end and a bottom end forming a downwardly open container having an exterior surface, an interior surface, and a rim at the bottom end defining an opening into an interior;
a second flange formed at the second section opening, comprising an exterior surface forming an upper ridge and a lower ridge;
a first bollard extending from the first section exterior surface adjacent the rim;
a second bollard extending from the second section exterior surface adjacent the rim forming a lower extension interrupting the upper ridge, wherein the first section and the second section are releasably connected at their openings forming a sealed container with a midsection disposed between the first section top end and second bottom top end, whereupon the second bollard is received within the opening in the first flange.

19. The container of claim 18, further comprising:
a plane extending through an axis of the container the first bollard;
a first coating coating at the exterior of the container covering the first section and the second section forming an edge adjacent the plane;
a second candy coating at the exterior of the container covering the first section and the second section forming an edge adjacent the longitudinal plane, wherein the first and second bollards are disposed along the plane between the first and second candy coatings.

20. The container of claim 19, further comprising a covering about the exterior of the first and second candy coatings.

21. The container of claim 18, further comprising:
a plane extending through an axis and the first bollard;
a third bollard extending from the first section exterior surface at the bottom end; and
a fourth bollard extending from the second section exterior surface at the top end, wherein the first, second, third, and fourth bollards are disposed along the plane, and wherein the third bollard is widely spaced from the first bollard, and the fourth bollard is widely spaced from the second bollard.

22. A container having a longitudinal axis greater than a transverse axis, comprising:
a first section extending between a top end and a bottom end forming an exterior surface, an interior surface, and a rim defining an opening into an interior;
a second section extending between a top end and a bottom end forming an exterior surface, and interior surface, and a rim defining an opening into an interior;
a first bollard extending from a left side of the first section exterior surface adjacent the rim;
a second bollard extending from a left side the second section exterior surface adjacent the rim; wherein the first section and the second section are releasably connected at their openings forming a sealed container with a midsection disposed between the first section and second section, and wherein the first bollard is opposite the second bollard at the midsection;
a first candy coating at the exterior of the container covering the first section and the second section forming an edge adjacent a longitudinal plane extending through the longitudinal axis and the left side;
a second candy coating at the exterior of the container covering the first section and the second section forming an edge adjacent the longitudinal plane, wherein the first and second bollards are disposed along the longitudinal plane between the first and second confectionary coatings; and a covering about the exterior of the first and second confectionary coatings.

23. The container of claim 22, further comprising a plurality of widely spaced bollards at the exterior of the first and second halves aligned along the longitudinal plane extending through the longitudinal axis and the left side.

24. The container of claim 22, wherein the first section rim forms an opening at the left side; the second bollard forms a lower extension; and the lower extension is disposed within the gap when the first section and second section are connected by their openings.

25. The container of claim 24, further comprising:
a first section flange formed at the first section opening, comprising an interior surface forming an upper groove and a lower groove wherein the upper groove is interrupted by the first section opening;
a second section flange formed at the second section opening, comprising an exterior surface forming an upper ridge and a lower ridge; and wherein the upper ridge is interrupted by the lower extension.

26. The container of claim 22, further comprising an object disposed within the first section and second section interior.
